(19) United States
(12) Patent Application Publication
(10) Pub. No.: US 2006/0168529 A1
(43) Pub. Date: Jul. 27, 2006

(54) Integrated management of in-person and virtual meeting attendence

(75) Inventors: Vaughn Rokosz, Newton, MA (US); Patrick O'Sullivan, Dublin (IE)

Correspondence Address: Steven M. Greenberg, Esquire;Christopher & Welsberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/017,001

(22) Filed: Dec. 20, 2004

(51) Int. Cl. G06F 17/00; G06F 3/00

(52) U.S. Cl. 715/751

(57) ABSTRACT

A method, system and apparatus for the integrated management of in-person and e-meeting attendance. A system for the consolidated management of an attendance list for a hybrid meeting can include a collaborative bridge configured for coupling both to an in-person meeting and an e-meeting, a data store of integrated attendance, and attendance integration logic programmed to manage a consolidated attendance list in the data store for the in-person meeting and the e-meeting by accessing attendance information through the collaborative bridge. Notably, the in-person meeting can include a sensor coupled to the collaborative bridge and configured to detect a presence of tags affixed to participants to the in-person meeting to manage the attendance information for the in-person meeting. As an example, the sensor and tags can be a radio frequency identification (RFID) sensor and corresponding RFID tags, a badge reader and corresponding badges, or at least one wireless access point and corresponding wireless transmitters.

### BACKGROUND OF THE INVENTION

1. Statement of the Technical Field

The present invention relates to the field of collaborative systems and more particularly the present invention relates to the field of attendance management in a collaborative system.

2. Description of the Related Art

The rapid development of the Internet has led to advanced modes of communication and collaboration. Using the Internet as a backbone, individuals worldwide can converge in cyberspace to share ideas, documents and images in a manner not previously possible through conventional telephony and video conferencing. To facilitate collaboration over the Internet, a substantial collection of technologies and protocols have been assembled to effectively deliver audio, video and data over the single data communications medium of the Internet. These technologies include both static synchronous forms of collaboration such as instant messaging and application sharing, and asynchronous forms of collaboration such as discussion forums and document libraries.

An e-meeting represents one popular form of electronic collaboration. In an e-meeting, participants can view a common space, for instance a whiteboard or a shared application (or both), through which ideas can be exchanged. The viewing of the common space can be complemented with a teleconference, a videoconference, an instant messaging session, or any combination thereof, such that the e-meeting can act as a near substitute for an in-person meeting in a conference room. Notwithstanding, many prefer an old-fashioned in-person meeting to an e-meeting of the modern computing infrastructure.

In an in-person meeting, the context and content of presentation ideas and materials can be established based upon the attendees present in the meeting. Determining the identity and nature of the attendees to an in-person meeting can be as simple as taking a visual scan of the room or conducting a roll call. In an e-meeting, however, a more explicit mechanism can be required. Specifically, as participants sign onto an e-meeting, the identities of the participants can be electronically collated and presented to the participants—typically in the form of a window list. As participants leave the e-meeting, the sign off process can cause the removal of the participant identity from the window list.

While both in-person meetings and e-meetings enjoy widespread use, on occasion an in-person meeting can merge with an e-meeting to form a hybrid meeting. In a hybrid meeting, a group of participants can congregate in person in a meeting room and an e-meeting can be established among those present in the in-person meeting and additional participants not present in the in-person meeting. Where additional collaborative tools such as application sharing occur in a hybrid meeting, an in-person attendee can act as a conduit for a remote, electronic participant. Yet, in the hybrid circumstance, e-meeting participants remain unaware of the participants to the in-person meeting. Accordingly, the hybrid meeting moderator must resort to a manual mechanism such as a roll-call in order to integrate the attendance list for the in-person portion of the meeting with the attendance list for the e-meeting.

### SUMMARY OF THE INVENTION

The present invention addresses the deficiencies of the art in respect to attendance list management in collaborative environment and provides a novel and non-obvious method, system and apparatus for the integrated management of in-person and e-meeting attendance. In this regard, a system for the consolidated management of an attendance list for a hybrid meeting can include a collaborative bridge configured for coupling both to an in-person meeting and an e-meeting, a data store of integrated attendance, and attendance integration logic programmed to manage a consolidated attendance list in the data store for the in-person meeting and the e-meeting by accessing attendance information through the collaborative bridge.

Notably, the data store and the attendance integration logic can be disposed in the collaborative bridge. Moreover, the in-person meeting can include a sensor coupled to the collaborative bridge and configured to detect a presence of tags affixed to participants to the in-person meeting to manage the attendance information for the in-person meeting. As an example, the sensor and tags can be a radio frequency identification (RFID) sensor and corresponding RFID tags, a badge reader and corresponding badges, or at least one wireless access point and corresponding wireless transmitters.

A method for integrating an attendance list for a hybrid meeting can include establishing an attendance list for an in-person meeting and further establishing an attendance list for an e-meeting. Advantageously, the attendance lists can be consolidated into a single attendance list for a hybrid meeting including the in-person meeting and the e-meeting. In a preferred aspect of the invention, the step of establishing an attendance list for the in-person meeting can include sensing tags as the tags come into proximity of the in-person meeting, determining participant identities associated with the sensed tags, and adding the identities to the attendance list for the in-person meeting. The method further can include detecting when the sensed tags no longer are in proximity of the in-person meeting, and removing identities for the sensed tags no longer in proximity of the in-person meeting from the attendance list for the in-person meeting.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a collaborative system configured for attendance integration in accordance with the inventive arrangements; and,

FIG. 2 is a flow chart illustrating a process for attendance integration in the system of FIG. 1.

### DETAILED DESCRIPTION OF THE PREFERRED EMBODIMENTS

The present invention is a method, system and apparatus for tracking and integrating attendance in a hybrid meeting. In accordance with the present invention, a hybrid meeting can be established among in-person meeting participants and e-meeting participants. The attendance of the e-meeting participants can be tracked as can the attendance for the in-person meeting. In the case of the in-person meeting, the tracking of attendance can be automated through the use of presence detection configured to sense the presence of in-person meeting participants. Both the attendance for the e-meeting and the in-person meeting can be consolidated into a single view of attendance for the hybrid meeting. In this way, each participant in the meeting can maintain an awareness of each other participant, regardless of whether the participants attend the in-person meeting or the e-meeting.

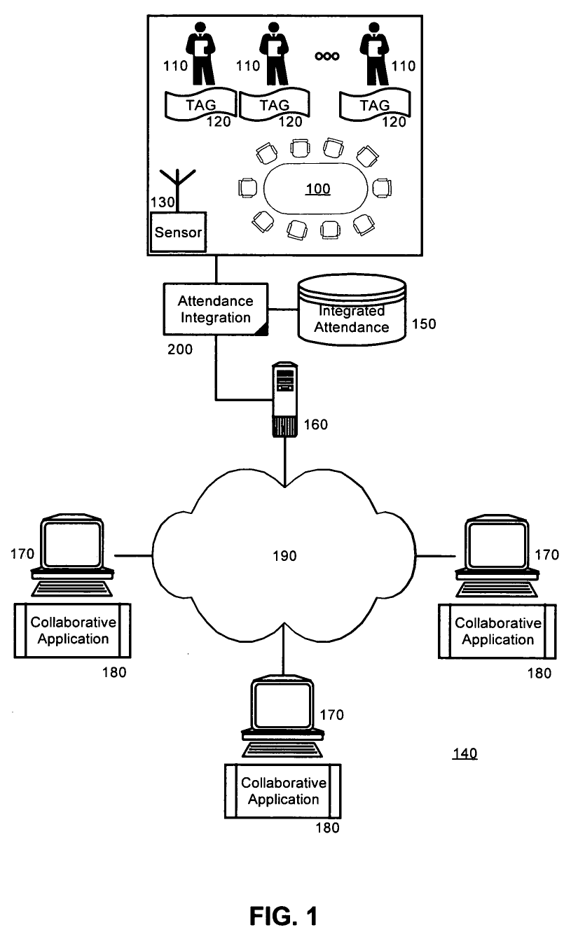

In further illustration, FIG. 1 is a schematic illustration of a collaborative system configured for attendance integration in accordance with the inventive arrangements. The system can be a hybrid meeting system include both an in-person meeting 100 and an e-meeting 140. The in-person meeting 100 can include one or more in-person participants 110, and the e-meeting 140 can include one or more electronic participants 170 communicatively coupled to one another over a computer communications network 190.

Each of the electronic participants 170 can include at least one collaborative computing application 180 programmed to facilitate the establishment and maintenance of the e-meeting 140. As part of the programming of the collaborative computing application 180, an attendance list can be maintained for the electronic participants 170 in the e-meeting 140. Notably, a collaborative bridge 160 can be coupled to the e-meeting 140 and to the in-person meeting 100.

The collaborative bridge 160 can include both a data store of integrated attendance 150 and also attendance integration logic 200. The attendance integration logic 200 can include programming to trace the attendance of the electronic participants 170 in the e-meeting 140, as well as the attendance of the participants 110 to the in-person meeting 100. In this regard, as participants 110 enter and leave the in-person meeting 100, the attendance integration logic 200 can insert and remove the identities of the entering and leaving participants, respectively, in the data store of integrated attendance 150. Likewise, the attendance integration logic 200 can update the data store of integrated attendance 150 as participants 170 to the e-meeting 140 enter and leave the e-meeting 140. Finally, when the e-meeting terminates, the entries in the data store of integrated attendance 150 associated with the e-meeting 140 can be removed.

In a base implementation of the present invention, a moderator (not shown) can track the entrance and egress of participants 110 to the in-person meeting 100. The moderator can feed the attendance data directly to the attendance integration logic 200. In an advanced aspect of the invention, however, the process of tracking the entrance and egress of participants 110 to the in-person meeting 100 can be automated. Specifically, each of the participants 110 can be equipped with a tag 120 and a sensor 130 can be disposed in the proximity to the in-person meeting 100. The sensor 130 can be configured to sense the presence of the tags 120.

In this regard, in a particular aspect of the invention, the tags 120 can be RFID tags and the sensor 130 can be an RFID transceiver and processor. In another aspect of the invention, the tags can be badges and the sensor 130 can be a badge reader such that participants 110 to the in-person meeting 100 can swipe the badges through the badge reader when entering and exiting the conference room. In yet another aspect of the invention, the tags 120 can be a wireless transmitter such as a Wi-Fi or Bluetooth device, and the sensor 130 can be a wireless receiver such as one or more wireless access points disposed within the conference room of the in-person meeting 100.

Importantly, the tags 120 can include data sufficient for identifying a corresponding one of the participants 110. When the sensor 130 detects the presence of the tags 120, the data disposed within the tags 120 can be passed to the sensor 130. In this way, as the sensor 130 detects the presence of the tags 120, the sensor 130 can determine which of the participants 110 has entered the in-person meeting 100. Moreover, as participants 110 exit the in-person meeting 100, the sensor 130 can determine which of the participants 110 have left based upon the ability of the sensor 130 to identify all tags 120 remaining in proximity to the sensor 130 and those tags 120 which had been in proximity to the sensor 130 but which no longer can be sensed.

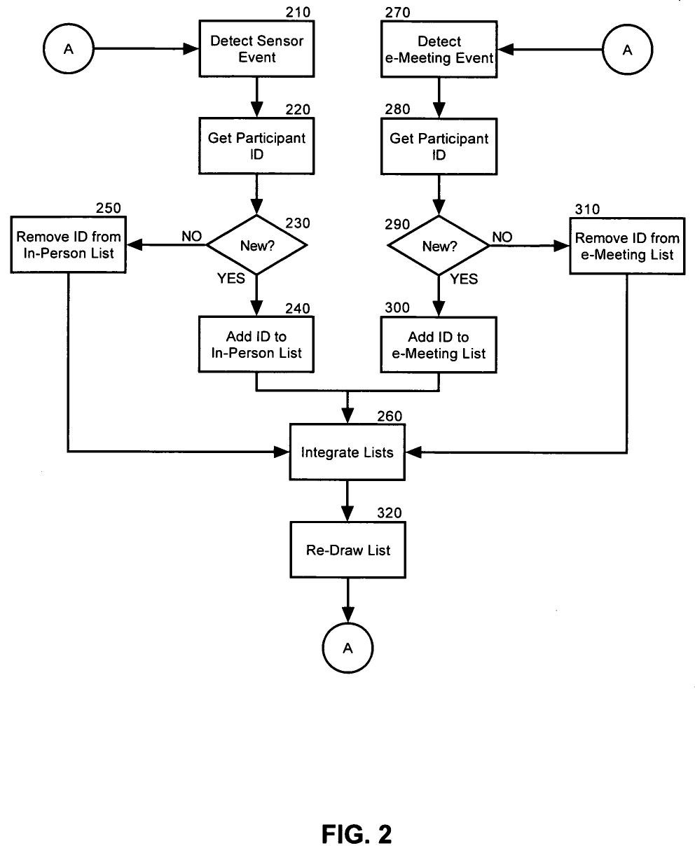

In more particular illustration of an advanced embodiment of the present invention, FIG. 2 is a flow chart illustrating a process for attendance integration in the system of FIG. 1. In the process of the invention, a hybrid meeting can be established which can include an in-person meeting and an e-meeting. First considering the in-person meeting, beginning in block 210 a sensor event can be detected indicating the entrance or egress of a participant to the in-person meeting. Subsequently, in block 220, the identity of the participant associated with the event can be determined.

In decision block 230, it can be determined whether the participant is new to the attendance list for the in-person meeting, indicating that the participant has entered the in-person meeting, or whether the participant had been included in the attendance list for the in-person meeting, indicating that the participant has exited the in-person meeting. If the participant has exited the in-person meeting, the identity of the participant can be removed from the attendance list for the in-person meeting in block 250. Otherwise, the identity of the participant can be added to the attendance list for the in-person meeting in block 240.

Referring now to the e-meeting, beginning in block 270 an e-meeting event can be detected indicating the entrance or egress of a participant to the e-meeting. Subsequently, in block 280, the identity of the participant associated with the event can be determined. In decision block 290, it can be determined whether the participant is new to the attendance list for the e-meeting, indicating that the participant has entered the e-meeting, or whether the participant had been included in the attendance list for the e-meeting, indicating that the participant has exited the e-meeting. If the participant has exited the e-meeting, the identity of the participant can be removed from the attendance list for the e-meeting in block 310. Otherwise, the identity of the participant can be added to the attendance list for the e-meeting in block 300.

Whenever a participant is added or removed to an attendance list for either the in-person meeting, or the e-meeting, in block 260 the lists can be integrated to form a consolidate attendance list for the hybrid meeting. It will be recognized by the skilled artisan, however, that the consolidation of the attendance list need not occur at any particular time and other consolidation intervals can suffice. In any case, in block 320, the consolidated attendance list can be redrawn such that the participants to the e-meeting and those having access to a display of the consolidate list in the in-person meeting can view a consolidated listing of all participants to the hybrid meeting.

The present invention can improve the experience of the participants to a hybrid meeting by providing the participants with a complete view of the attendees to the meeting. In contrast, present solutions limit the view to the participants to the e-meeting only. By viewing a consolidated list of attendees, including people attending the hybrid meeting in-person in conference rooms, remote presenters can tailor presentations to the entire audience. Moreover, remote participants can provide presentation comments which are appropriate to the audience. Additionally, a meeting moderator can use the integrated attendance list to more efficiently take attendance, or to build a mailing list of people to whom meeting minutes can be sent, or to capitalize upon computer-supported action item assignment.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A system for the consolidated management of an attendance list for a hybrid meeting, the system comprising:
a collaborative bridge configured for coupling both to an in-person meeting and an e-meeting;
a data store of integrated attendance; and,
attendance integration logic programmed to manage a consolidated attendance list in said data store for said in-person meeting and said e-meeting by accessing attendance information through said collaborative bridge.

2. The system of claim 1, wherein said data store and said attendance integration logic are disposed in said collaborative bridge.

3. The system of claim 1, wherein said in-person meeting comprises a sensor coupled to said collaborative bridge and configured to detect a presence of tags affixed to participants to said in-person meeting to manage said attendance information for said in-person meeting.

4. The system of claim 3, wherein said sensor and tags are a radio frequency identification (RFID) sensor and RFID tags, respectively.

5. The system of claim 3, wherein said sensor and tags are a badge reader and badges, respectively.

6. The system of claim 3, wherein said sensor and tags are a wireless access point and wireless transmitters, respectively.

7. A method for integrating an attendance list for a hybrid meeting, the method comprising the steps of:
establishing an attendance list for an in-person meeting;
further establishing an attendance list for an e-meeting; and,
consolidating the attendance lists into a single attendance list for a hybrid meeting comprising said in-person meeting and said e-meeting.

8. The method of claim 7, wherein said step of establishing an attendance list for said in-person meeting comprises the steps of:
sensing tags as said tags come into proximity of said in-person meeting;
determining participant identities associated with said sensed tags; and,
adding said identities to said attendance list for said in-person meeting.

9. The method of claim 8, further comprising the steps of:
detecting when said sensed tags no longer are in proximity of said in-person meeting; and,
removing identities for said sensed tags no longer in proximity of said in-person meeting from said attendance list for said in-person meeting.

10. The method of claim 7, wherein said sensing step comprises the step of sensing radio frequency identification (RFID) tags as said RFID tags come into proximity of said in-person meeting.

11. The method of claim 10, wherein said determining step comprises the step of extracting said participant identities from said RFID tags.

12. The method of claim 7, wherein said sensing step comprises the step of sensing badges as said badges are swiped through a badge reader disposed in said in-person meeting.

13. The method of claim 7, wherein said sensing step comprises the step of sensing wireless transmitters as said wireless transmitters come into proximity to at least one wireless access point in said in-person meeting.

14. A machine readable storage having stored thereon a computer program for integrating an attendance list for a hybrid meeting, the computer program comprising a routine set of instructions which when executed by a machine causes the machine to perform the steps of:
establishing an attendance list for an in-person meeting;
further establishing an attendance list for an e-meeting; and,
consolidating the attendance lists into a single attendance list for a hybrid meeting comprising said in-person meeting and said e-meeting.

15. The machine readable storage of claim 14, wherein said step of establishing an attendance list for said in-person meeting comprises the steps of:
sensing tags as said tags come into proximity of said in-person meeting;
determining participant identities associated with said sensed tags; and,
adding said identities to said attendance list for said in-person meeting.

16. The machine readable storage of claim 15, further comprising an additional set of instructions which when executed by the machine causes the machine to further perform the steps of:
detecting when said sensed tags no longer are in proximity of said in-person meeting; and,
removing identities for said sensed tags no longer in proximity of said in-person meeting from said attendance list for said in-person meeting.

17. The machine readable storage of claim 14, wherein said sensing step comprises the step of sensing radio frequency identification (RFID) tags as said RFID tags come into proximity of said in-person meeting.

18. The machine readable storage of claim 17, wherein said determining step comprises the step of extracting said participant identities from said RFID tags.

19. The machine readable storage of claim 14, wherein said sensing step comprises the step of sensing badges as said badges are swiped through a badge reader disposed in said in-person meeting.

20. The machine readable storage of claim 14, wherein said sensing step comprises the step of sensing wireless transmitters as said wireless transmitters come into proximity to at least one wireless access point in said in-person meeting.
